(19) United States
(12) Patent Application Publication
(10) Pub. No.: US 2022/0309438 A1
(43) Pub. Date: Sep. 29, 2022

(54) AUTOMATED CLAIMS ADJUSTMENT ASSIGNMENT UTILIZING CROWDSOURCING AND ADJUSTER PRIORITY SCORE DETERMINATIONS

(71) Applicant: Allstate Insurance Company, Northbrook, IL (US)

(72) Inventors: Rohit Basuri, Bangalore (IN); Anupam Adhikari, Bangalore (IN)

(73) Assignee: Allstate Insurance Company, Northbrook, IL (US)

(21) Appl. No.: 17/213,602

(22) Filed: Mar. 26, 2021

(51) Int. Cl. G06Q 10/06; G06Q 50/00; G06Q 40/08

(52) U.S. Cl. CPC G06Q 10/063112; G06Q 50/01; G06Q 40/08

(57) ABSTRACT

An intelligent adjuster assignment system includes a crowdsourcing platform, one or more processors, one or more memory components, and machine readable instructions that cause the intelligent adjuster assignment system to: receive an insurance claim during a period of time, determine a plurality of real-time adjuster priority scores based on one or more weighted parameters for a plurality of adjusters of an adjuster pool on the crowdsourcing platform during the period of time, determine a top-ranked adjuster from the plurality of adjusters based on the plurality of real-time adjuster priority scores, and assign the insurance claim to the top-ranked adjuster.

### TECHNICAL FIELD

The present specification generally relates to intelligent adjuster assignment systems and methods and, more specifically, intelligent adjuster assignment systems and methods for assignment of an insurance claim to an adjuster using a crow-sourcing platform and a real-time adjuster priority score.

### BACKGROUND

Handling insurance claims can be a time-consuming and complex process for both the claimant and an insurance provider as the claims processor. The claimant often starts the process with a first notice of loss or insurance claim to a claims processer associated with a claims processing office of an insurance company. A claims adjuster or adjuster within the claims processing office may then be assigned to the case to assess the damage for which compensation is sought. A need exists to more efficiently and effectively streamline the assignment of claims adjusters to submitted claims.

### SUMMARY

In accordance with one embodiment of the present disclosure, an intelligent adjuster assignment system may include a crowdsourcing platform, one or more processors, one or more memory components communicatively coupled to the one or more processors and the crowdsourcing platform, and machine readable instructions stored in the one or more memory component. The machine readable instructions may cause the intelligent adjuster assignment system to perform at least the following when executed by the one or more processors: receive an insurance claim during a period of time, determine a plurality of real-time adjuster priority scores based on one or more weighted parameters for a plurality of adjusters of an adjuster pool on the crowdsourcing platform during the period of time, determine a top-ranked adjuster from the plurality of adjusters based on the plurality of real-time adjuster priority scores, and assign the insurance claim to the top-ranked adjuster.

In accordance with another embodiment of the present disclosure, an intelligent adjuster assignment system may include a crowdsourcing platform, one or more processors, one or more memory components communicatively coupled to the one or more processors and the crowdsourcing platform, and machine readable instructions stored in the one or more memory component. The machine readable instructions may cause the intelligent adjuster assignment system to perform at least the following when executed by the one or more processors: receive an insurance claim during a period of time, determine a plurality of real-time adjuster priority scores based on one or more weighted parameters for a plurality of adjusters of an adjuster pool on the crowdsourcing platform during the period of time, select adjusters that are identified as actively accepting claims for the plurality of adjusters from the adjuster pool, determine a top-ranked adjuster from the plurality of adjusters that are actively accepting claims based on the plurality of real-time adjuster priority scores, assign the insurance claim to the top-ranked adjuster, and train the intelligent adjuster assignment system to adjust the one or more weighted parameters based on a history of claim assignments for each adjuster.

In accordance with another embodiment of the present disclosure, a method of implementing an intelligent adjuster assignment system may include receiving an insurance claim during a period of time, determining a plurality of real-time adjuster priority scores based on one or more weighted parameters for a plurality of adjusters of an adjuster pool on a crowdsourcing platform during the period of time, determining a top-ranked adjuster from the plurality of adjusters based on the plurality of real-time adjuster priority scores, and assigning the insurance claim to the top-ranked adjuster.

Although the concepts of the present disclosure are described herein with primary reference to insurance claims and insurance adjusters, it is contemplated that the concepts will enjoy applicability to any setting for purposes of intelligent adjuster assignment solutions, such as alternative business settings or otherwise, including and not limited to, non-insurance related bidding and personnel assignments (e.g., other service).

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts an intelligent adjuster assignment solution including an adjuster assignment model, according to one or more embodiments shown and described herein;

FIG. 2 illustrates a computer intelligent adjuster assignment system including the intelligent adjuster assignment model of FIG. 1 for use in the process flows described herein, according to one or more embodiments shown and described herein;

FIG. 3 depicts a schematic illustration of the intelligent adjuster assignment system such as shown in FIG. 2 in an operating environment, according to one or more embodiments shown and described herein; and

FIG. 4 depicts a flowchart process for use of the intelligent adjuster assignment solution of FIG. 1 and the intelligent adjuster assignment system of FIG. 2, according to one or more embodiments shown and described herein.

### DETAILED DESCRIPTION

In embodiments described herein, an intelligent adjuster assignment system is configured to implement systems and methods to assign insurance claims to adjusters on a crowdsourcing platform. Claims processor or insurance providers may receive claims from customers or insurance claimants for assignment to an adjuster. The assigned adjuster may then investigates the insurance claim to determine whether the insuring company is liable and, if so, to what extent. Insurance claims can be related to property damage or theft claims (e.g., of property such as structures, vehicles, jewelry, etc.), injury claims, medical claims, or the like. An adjuster typically interviews parties related to the claims (e.g., claimant, witnesses, experts, etc.), reviews records (e.g., police, medical, sales, etc.), and inspects other evidence (e.g., involved property, locations, etc.). The adjuster then determines a monetary amount or other remedy to provide the claimant and settle the claim. Claimants, in turn, may appeal the monetary amount or other decisions made by the adjuster. The process of receiving, investigating, and settling insurance claims can be time consuming and costly based on factors, such as the assigned adjustor. For instance, the particular adjuster assigned to an insurance claim may directly affect the time, cost, satisfaction of customers, and the like.

Embodiments described herein provide an intelligent adjuster assignment system that is configured to implement systems and methods to (i) determine a plurality of real-time adjuster priority scores for adjusters in a crowdsourcing platform, and (ii) to assign a top-ranked adjuster to process or handle the insurance claim based on the determined real-time adjuster priority scores. By providing such a crowdsourcing platform, the intelligent adjuster assignment system may select a top-ranked adjuster from a large group of adjusters while leveraging crowdsourced environments. The crowdsourcing platform may allow insurance providers to outsource assignments to large groups of adjusters via an online community or crowd of workers (e.g., “crowdworkers”). The crowdsourcing platform may outsource adjuster tasks and services instead of or in addition to assigning tasks or services to employees or contractors of the insurance provider. By generating real-time adjuster priority scores, intelligent adjuster assignment systems described herein may assign claims to crowdworker adjusters based on skill, experience, predicted likelihood of a satisfactory outcome (e.g., speed, cost, satisfaction of customers, or the like), or the like.

Accordingly, systems and methods as provided herein provide for an intelligent adjuster assignment system including a crowdsourcing platform that receives an insurance claim and assigns the insurance claim to a top-ranked adjuster from an adjuster pool of the crowdsourcing platform based on real-time adjuster priority scores. In embodiments, systems and methods as described herein may also train the intelligent adjuster assignment system to adjust one or more weighted parameters utilized for determining real-time adjuster priority scores, such as training based on a history of claim assignments. These and additional features will be described in greater detail below.

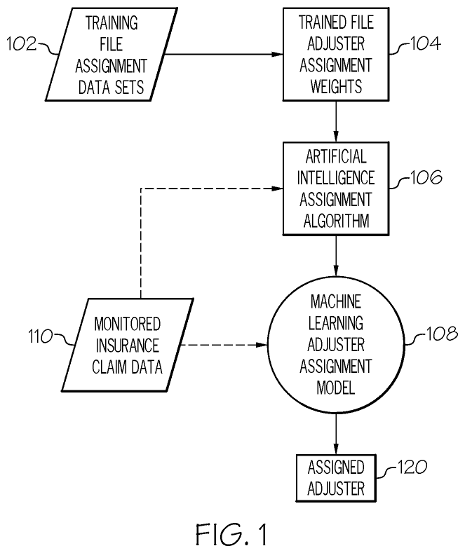

Referring now to FIG. 1, in embodiments, an intelligent adjuster assignment solution 100 includes one or more training file assignment data sets 102, one or more trained file adjuster assignment weights 104, an artificial intelligence assignment algorithm 106, a machine learning adjuster assignment model 108, monitored insurance claim data 110, and an assigned adjuster 120. The machine learning adjuster assignment model 108 utilizes the artificial intelligence assignment algorithm 106 to generate the assigned adjuster 120 associated with and based on the monitored insurance claim data 110. The machine learning adjuster assignment model 108 and the artificial intelligence assignment algorithm 106 may be trained using the one or more training file assignment data sets 102, which are associated during training with the one or more trained file adjuster assignment weights 104. Thus, during training, input from the one or more training file assignment data sets 102, such as sample or historical insurance claims and assignments, is associated with trained file adjuster assignment weights 104 to train the artificial intelligence assignment algorithm 106 to assign the insurance claim to a particular assigned adjuster 120 based one on or more weighted parameters as described herein. Additionally, the machine learning adjuster assignment model 108 may be configured to utilize one or more insurance claims from the monitored insurance claim data 110 to generate one or more trained file assignments to use to adjust and reduce error for the one or more trained file adjuster assignment weights 104.

The one or more training file assignment data sets 102 may include past adjuster assignments (e.g., a history of assignments), parameters of received claims, adjuster data, and related outcomes from the past adjuster assignments. For instance, the one or more training file assignment data sets 102 may include sets of past claims, outcomes, assigned adjusters, one or more weighted parameters utilized to determine real-time adjuster priority scores, and the like. The one or more weighted parameters may include, for example, an adjuster rating based on whether the adjuster is a customer of an insurance platform provider, an adjuster location rating based on a distance each of the plurality of adjusters is to a location defined by the insurance claim, an average insurance claims settlement cycle time value for each of the plurality of adjusters, a platform average winning bid value, a history of success settlement parameter, a number of claims adjusted parameter, an adjuster history parameter including legal history, a user rating for each of the plurality of adjusters, a reverse bidding algorithm to indicate adjuster preference, or a combination thereof. In embodiments, the one or more training file assignment data sets 102 may include historic information that may be updated, monitored, and recorded.

The assigned adjuster 120 may be determined based on real-time adjuster priority scores. Further, the real-time adjuster priority scores may be determined based on the machine learning adjuster assignment model 108 utilizing the artificial intelligence assignment algorithm 106 as described herein. The artificial intelligence assignment algorithm 106 may be trained utilizing historic monitored insurance claim data 110, training file assignment data sets 102, trained filed adjuster assignment weights, and the like. The artificial intelligence assignment algorithm 106 may thus be trained to learn to adjust and reduce error associated with assignment weights of one or more weighted parameters that are utilized to determine real-time adjuster priority scores, which are thereby utilized by the machine learning adjuster assignment model 108 for determining an assigned adjuster 120. As a non-limiting example, the artificial intelligence assignment algorithm 106 may be trained to adjust weights of one or more weighted parameters based on a history of claims assignments for each adjuster or for a plurality of adjusters (e.g., all adjusters, adjuster in a particular location, adjusters active during particular periods, or the like). Thus, weights may be adjusted such that adjusters are assigned based on predicted positive or satisfactory outcomes.

The machine learning adjuster assignment model 108 may be communicatively coupled to a “big data” environment including a database configured to store and process large volumes of data in such an environment. The database may be, for example, a structured query language (SQL) database or a like database that may be associated with a relational database management system (RDBMS) and/or an object-relational database management system (ORDBMS). The database may be any other large-scale storage and retrieval mechanism including, but not limited to, a SQL, SQL including, or a non-SQL database. For example, the database may utilize one or more big data storage computer architecture solutions. Such big data storage solutions may support large data sets in a hyperscale and/or distributed computing environment, which may, for example, include a variety of servers 220 (described further below) utilizing direct-attached storage (DAS). Such database environments may include Hadoop, NoSQL, and Cassandra that may be usable as analytics engines. Thus, while SQL may be referenced herein as an example database, it is understood that any other type of database capable of supporting large amounts of data, whether currently available or yet-to-be developed, and as understood to those of ordinary skill in the art, may be utilized.

In embodiments, the intelligent adjuster assignment solution 100 utilizes an intelligent or machine learning adjuster assignment model 108 to automatically assign adjusters to an insurance claim based on monitored insurance claim data 110 and other parameters as described herein. As a non-limiting example, the monitored insurance claim data 110 includes insurance claim requests including identified parameters of an insurance claim. Such identified parameters of an insurance claim may include a customer or claimant identification (e.g., customer ID), insurance plan data (e.g., deductible, covered events, etc.), loss data (e.g., description of property, description of person/injury, etc.), location data (e.g., location of property, location of incident, etc.), time data (e.g., time of incident, time of claim, etc.), or the like. Such monitored insurance claim data 110 may be provided or received from computing devices, telephone conversations, documents, or the like. For instance, a claimant may utilize a computing device (e.g., cellphone, personal computer, etc.) to access an insurance provider website and file a claim. It is noted that embodiments may utilize various appropriate processes for collecting and receiving monitored insurance claim data 110.

In some embodiments, monitored insurance claim data 110 may include any information known about the claimant from one or more claimant information sources (e.g., inputs provided by a claimant, information stored on a remote server, local memory, or the like). For example, claimant information sources may include information such as, but not limited to, age, gender, existing policies, address, past claims, credit score, payment history, length of time with insurance provider, etc. As will be described in greater detail herein, the monitored insurance claim data 110 may be used to generate determine real-time adjuster priority scores. The real-time adjuster priority scores may thereafter be utilized to assign adjusters to tasks related to processing an insurance claim such that an adjuster with a top-ranking score is assigned to an receive and evaluated claim.

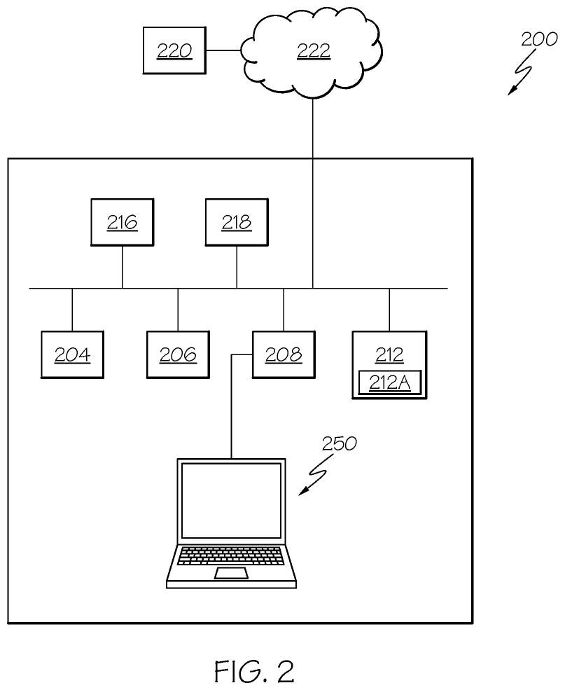

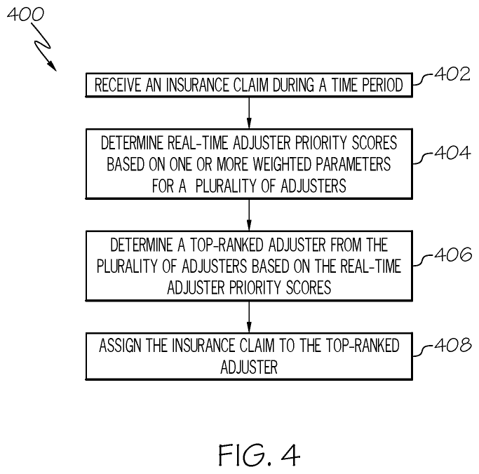

FIG. 2 illustrates a computer implemented intelligent adjuster assignment system 200 for use with the intelligent adjuster assignment solution 100 of FIG. 1 and the processes described herein, such as process 400 of FIG. 4 described in greater detail below. Referring to FIG. 2, a non-transitory, intelligent adjuster assignment system 200 is configured for implementing a computer and software-based method, such as directed by the intelligent adjuster assignment solution 100 and the processes described herein, to automatically assign adjusters to insurance claim requests. The intelligent adjuster assignment system 200 includes the machine learning adjuster assignment model 108 of FIG. 1 to generate the assigned adjuster 120 (FIG. 1) for an insurance claim. The intelligent adjuster assignment system 200 further includes a communication path 202, one or more processors 204, a non-transitory memory component 206, a claims analysis module 212 (e.g., to implement the artificial intelligence assignment algorithm 106 of FIG. 1 via a neural network model), a training module 212A of the claims analysis module 212 (e.g., to train the artificial intelligence assignment algorithm 106 of FIG. 1), a machine-learning module 216 (e.g., to implement the machine learning adjuster assignment model 108 of FIG. 1), network interface hardware 218, input/output controller 208, and input/output device(s) 250 (e.g., such as displays, point devices, touch screens, etc.). In some embodiments, the intelligent adjuster assignment system 200 may include or be communicatively coupled to one or more remote servers 220 through a network 222. It is noted that systems according to the present disclosure may include a greater or fewer number of modules without departing from the scope of the present disclosure. The lines depicted in FIG. 2 indicate communication rather than physical connection between the various components.

An input/output device 250 of the intelligent adjuster assignment system 200 may include a mobile smart device, a laptop computer, a desk top computer, server computer, or the like. In embodiments, components of the intelligent adjuster assignment system 200 may include one or more input/output devices 250.

As noted above, the intelligent adjuster assignment system 200 comprises the communication path 202. The communication path 202 may be formed from any medium that is capable of transmitting a signal such as, for example, conductive wires, conductive traces, optical waveguides, or the like, or from a combination of mediums capable of transmitting signals. The communication path 202 communicatively couples the various components of the intelligent adjuster assignment system 200. As used herein, the term “communicatively coupled” means that coupled components are capable of exchanging data signals with one another such as, for example, electrical signals via conductive medium, electromagnetic signals via air, optical signals via optical waveguides, and the like. Accordingly, communication may be facilitated through wired and/or wireless transmissions of data signals.

The intelligent adjuster assignment system 200 of FIG. 2 also comprises the processor 204. The processor 204 can be any device capable of executing machine-readable instructions. Accordingly, the processor 204 may be a controller, an integrated circuit, a microchip, a computer, or any other computing device. The processor 204 is communicatively coupled to the other components of the intelligent adjuster assignment system 200 by the communication path 202. Accordingly, the communication path 202 may communicatively couple any number of processors 204 with one another, and allow the modules coupled to the communication path 202 to operate in a distributed computing environment. Specifically, each of the modules can operate as a node that may send and/or receive data.

The illustrated intelligent adjuster assignment system 200 further comprises the memory component 206, which is coupled to the communication path 202 and communicatively coupled to the processor 204. The memory component 206 may be a non-transitory computer readable medium or non-transitory computer readable memory and may be configured as a nonvolatile computer readable medium. The memory component 206 may include RAM, ROM, flash memories, hard drives, or any device capable of storing machine-readable instructions such that the machine-readable instructions can be accessed and executed by the processor 204. The machine-readable instructions may include logic or algorithm(s) written in any programming language such as, for example, machine language that may be directly executed by the processor 204, or assembly language, object-oriented programming (OOP), scripting languages, microcode, etc., that may be compiled or assembled into machine-readable instructions and stored on the memory component 206. Alternatively, the machine-readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in computer programming languages, as pre-programmed hardware elements, or as a combination of hardware and software components.

The intelligent adjuster assignment system 200 may include the claims analysis module 212 and the machine-learning module 216, as described above, communicatively coupled to the one or more processors 204. The claims analysis module 212 may be configured to apply artificial intelligence algorithms and models to received insurance claims (e.g., such as monitored insurance claim data 110) via the network 222 to determine a real-time adjuster priority score for each analyzed adjuster as described herein.

The claims analysis module 212 may include machine readable instructions stored in the one or more memory components 206 that cause the intelligent adjuster assignment system 200 to perform actions, processes, or methods as described herein. The claims analysis module 212 may receive an insurance claim during a period of time. The insurance claim may be received via the network 222, such as via a communicatively coupled input/output device 250, or the like. In some non-limiting examples, the claims analysis module 212 may receive insurance claims from computing devices, telephone conversations, documents, or the like. For instance, a claimant may utilize a computing device (e.g., smartphone, personal computer, etc.) to access an insurance provider website and file a claim. It is noted that embodiments may utilize various appropriate processes for collecting and receiving monitored insurance claim data 110.

Referring again to FIG. 2, the intelligent adjuster assignment system 200 includes the network interface hardware 218 for communicatively coupling the intelligent adjuster assignment system 200 with a computer network such as network 222. The network interface hardware 218 is coupled to the communication path 202 such that the communication path 202 communicatively couples the network interface hardware 218 to other modules of the intelligent adjuster assignment system 200. The network interface hardware 218 can be any device capable of transmitting and/or receiving data via a wireless network. Accordingly, the network interface hardware 218 can include a communication transceiver for sending and/or receiving data according to any wireless communication standard. For example, the network interface hardware 218 can include a chipset (e.g., antenna, processors 204, machine readable instructions, etc.) to communicate over wired and/or wireless computer networks such as, for example, wireless fidelity (Wi-Fi), WiMax, Bluetooth, IrDA, Wireless USB, Z-Wave, ZigBee, or the like.

The network 222 can include any wired and/or wireless network such as, for example, wide area networks, metropolitan area networks, the internet, an intranet, satellite networks, or the like. Accordingly, the network 222 can be utilized as an access point by the intelligent adjuster assignment system 200 to access one or more servers 220. The one or more servers 220 may generally comprise processors, memory, and chipset for delivering resources via the network 222. Resources can include providing, for example, processing, storage, software, and information from the one or more servers 220 to the intelligent adjuster assignment system 200 via the network 222. Additionally, it is noted that the one or more servers 220 and any additional servers 220 can share resources with one another over the network 222 such as, for example, via the wired portion of the network 222, the wireless portion of the network 222, or combinations thereof. In some examples, the one or more servers 220 may store, receive, or provide training file assignment data sets 102 and/or monitored insurance claim data 110 (FIG. 1).

As noted above, the intelligent adjuster assignment system 200 may include the input/output device(s) 250 for providing output and receiving input. For example, the input/output device(s) 250 may provide visual output such as, for example, information, graphical reports, messages, or a combination thereof. The input/output device(s) 250 may be coupled to input/output controller 208 which may comprise one or more of a data port, serial bus, local wireless controller, or the like. The input/output controller 208 may couple the input/output device(s) 250 to the communication path 202 such that the input/output device(s) 250 may be communicatively coupled to the processor 204. Accordingly, the communication path 202 communicatively couples the input/output device(s) 250 to other modules of the intelligent adjuster assignment system 200. The input/output device(s) 250 can comprise a display comprising any medium capable of transmitting an optical output such as, for example, a cathode ray tube, light emitting diodes, a liquid crystal display, a plasma display, or the like.

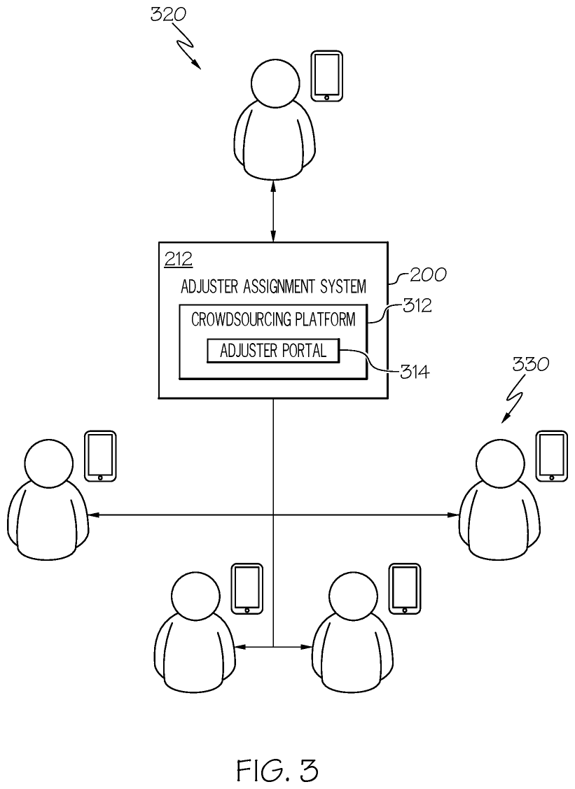

In embodiments, the claims analysis module 212 of FIG. 2 may determine a plurality of real-time adjuster priority scores based on one or more weighted parameters for a plurality of adjusters of an adjuster pool on a crowdsourcing platform 312 (FIG. 3) in an crowdsourcing environment during the period of time. A schematic of the intelligent adjuster assignment system 200 of FIG. 2 in such a crowdsourcing environment as an operating environment 300 is shown in FIG. 3.

Referring to FIG. 3, the operating environment 300 may include one more users or user devices 320, 330 associated with adjusters interacting with the intelligent adjuster assignment system 200 and claims analysis module 212 through a crowdsourcing platform 312 comprising and adjuster portal 314. In embodiments, the one or more user devices 320, 330 may include computing devices, such as the input/output devices 250 of FIG. 2, having a processor, such as a smartphone, laptop computer, wearable device, set-top box, desktop computer, tablet computer, or the like. User devices 320, 330 may be associated with user accounts. User accounts may be stored on a server (e.g., remote server 220) or may be otherwise accessed through a server. The user account includes attributes for a particular user and may include a unique identifier (ID) associated with the user, location, personal settings, and other information.

As shown in FIG. 3, the adjuster pool may comprise adjusters connected to an adjuster portal 314 on the crowdsourcing platform 312. In at least some embodiments, the claims analysis module 212 may identify adjusters to include in the adjuster pool based on (i) identifying adjusters that are logged into the crowdsourcing platform 312 and (ii) identified, via the adjuster portal 314, as actively accepting claims or not actively accepting claims. The claims analysis module 212 may select adjusters identified as actively accepting bids for inclusion in the adjuster pool or may otherwise filter adjusters not actively accepting bids when determining whether to assign an adjuster to an insurance claim. Adjusters may be identified as actively accepting claims or not actively accepting claims based on adjuster input or settings, system administrator controls, or a status of an adjuster (e.g., logged in/not logged in).

In an embodiment, the user devices 320, 330 may communicate with the adjuster portal 314. The adjuster portal 314 may comprise computer implemented instructions executed by a processor 204. The adjuster portal 314 may receive credentials from user devices 320, 330 and may allow a user to login or access aspects of the intelligent adjuster assignment system. In some examples, the adjuster portal 314 may allow the user devices 330 to provide or transmit updated information, such as a location indicative of an adjuster's current location. The current location may be determined automatically, such as by a global positioning system, network identification, or the like. In some embodiments, an adjuster may provide user input to identify a current location. The adjuster portal 314 may receive other information such as a status of an adjuster. The status of the adjuster may include, for example, whether the adjuster is actively accepting claims or is not actively accepting claims. A status may be determined by user input, according to machine learning, or the like.

The crowdsourcing platform 312 may include computer implemented instructions executed by a processor (e.g., the one or more processors 204, a processor of the remote server 220, etc.). In embodiments, the crowdsourcing platform 312 may be configured to distribute claim assignments to adjuster users, which may comprise individual crowdworkers. The crowdsourcing platform 312 may receive requests for insurance claims from policy holders, such as a policy holder utilizing a user device 320, and may assign an adjuster to the insurance claim as described herein. It is noted that the crowdsourcing platform 312 may provide user interfaces, via the adjuster portal 314, which may allow users to access the crowdsourcing platform, receive notifications or data, provide input, or the like.

The claims analysis module 212 may determine a plurality of real-time adjuster priority scores for a plurality of adjusters. For example, the claims analysis module 212 may determine priority scores for each adjuster in an adjuster pool on the crowdsourcing platform 312 in response to receiving an insurance claim. As such, the real-time adjuster priority scores may be determined during the same period of time that a claim is received such that the real-time adjuster priority scores reflect up-to-date scores. The claims analysis module 212 may determine the plurality of real-time adjuster priority scores based on one or more weighted parameters for a plurality of adjusters of an adjuster pool on the crowdsourcing platform during the period of time. As described herein, the claims analysis module 212 may apply the artificial intelligence assignment algorithm 106 (FIG. 1) to determine the real-time adjuster priority scores. In other examples, the claims analysis module 212 may utilize other algorithms which are not artificial intelligence algorithms.

In an embodiment, the claims analysis module 212 may calculate scores based on weights applied to the one or more weighted parameters. According to at least some examples, the weighted parameters may include (i) an adjuster rating based on whether the adjuster is a customer of an insurance provider, (ii) an adjuster location rating based on a distance each of the plurality of adjusters is to a location defined by the insurance claim, (iii) an average insurance claims settlement cycle time value for each of the plurality of adjusters, (iv) a platform average winning bid value, (v) a history of success settlement parameter, (vi) a number of claims adjusted parameter, (vii) an adjuster history parameter including legal history, (viii) a user rating for each of the plurality of adjusters, (ix) a reverse bidding algorithm to indicate adjuster preference, or (x) a combination thereof. It is noted that other or different parameters may be utilized and/or identified based on the trained file adjuster assignment weights 104 (FIG. 1). In non-limiting examples, priority may be given to adjusters that are also customers of the insurance provider. In another non-limiting example, the adjuster history parameter may identify a legal history that may be weighted such that priority is given to adjusters that do not have legal histories related to certain actions (e.g., fraud, crimes associated with truthfulness, etc.) It is noted that the legal history may be received periodically, such as upon an adjuster entering or being approved to participate in the intelligent adjuster assignment system 200 and/or at periodic timeframes thereon, and may be received from third party data sources, remote server 220, or the like.

The adjuster location rating may be weighted to prioritize shorter distances such that each of the plurality of adjusters that is a shorter distance to a location defined by the insurance claim receive priority over farther distances. An adjuster location may be defined as an adjuster's current location during the period of time, an adjuster's base or home location, or other suitable location associated with the adjuster. In examples, the claims analysis module 212 may determine an adjuster's location automatically, such as through a location service such as a global positioning system (“GPS”) location service and/or through stored data, or may allow an adjuster to provide input identifying a location via the adjuster portal 314.

According to embodiments, the claims analysis module 212 may apply a weight to the average insurance claims settlement cycle time value for each of the plurality of adjusters such that priority is given to each adjuster that has an average insurance claims settlement cycle time value under a threshold percentage of a global average insurance claims settlement cycle time. The threshold percentage may be, for example, under about 10% of a global average, under about 20% of the global average, under about 30% of the global average. In other non-limiting examples, weights may be adjusted such that priority is given to adjusters that are not over a threshold percentage above the global average insurance claims settlement cycle time (e.g., not over about 10%, about 20%, etc.). It is further noted that weights may be scaled, such that adjusters having an average insurance claims settlement cycle time value under a first threshold percentage are given a first weight, adjusters having an average insurance claims settlement cycle time value under a second threshold percentage are given a second weight, and so on. As such, priority may be scaled to favor adjusters that have shorter average insurance claims settlement cycle time values.

Additionally or alternatively, the platform average winning bid value may be weighted such that priority is given to each adjuster of the plurality of adjusters having a bid that is lower than the platform average winning bid value. For instance, the claims analysis module 212 may receive bids from adjusters via the adjuster portal 314. The claims analysis module 212 may determine a weight for a received bid based on a comparison between the received bid and a platform average winning bid value. It is noted that the weight may be scaled or the like. In another embodiment, the claims analysis module 212 may apply a reverse bidding algorithm to indicate adjuster preference. The reverse bidding algorithm may include machine readable instructions stored in memory that cause a processor to (i) receive a bid from at least one adjuster and (ii) assign a bid score to the at least one adjuster based on a comparison of the bid to at least one of a platform bid average or one or more competitive bids from other adjusters of the plurality of adjusters. For instance, the reverse bidding algorithm may assign priority to adjusters having a bid score that is within a predetermined percentage of a highest bid score (e.g., about 10%, about 20%, etc.). As above, it is noted that scaled weights may be applied.

The history of success settlement parameter may include a percentage score indicative of an amount of times a quote is unchallenged. For instance, a profile of an adjuster may identify past or historic insurance claims which the adjuster has handled. The results of the historic insurance claims may indicate whether a quote provided by the adjusters was challenged, unchallenged, overturned or adjusted, and/or was upheld. In examples, the claims analysis module 212 may apply weights based on the historic insurance claims handled by the adjusters. In an embodiment, the claims analysis module 212 may apply a weight such that priority is given to each adjuster having a percentage score indicative of the amount of times the quote is unchallenged that is greater than an unchallenged threshold value. The unchallenged threshold value may be, for instance, between about 75% and 100%, such as about 80%, about 90% or the like. Accordingly, adjusters of a pool of adjusters that have greater unchallenged or upheld quotes may be given priority. Moreover, the weights may be scaled to provide progressively greater priority to adjusters having greater successful quote rates.

In at least some embodiments, a number of claims adjusted parameter may be weighted such that priority is given to each adjuster of the plurality of adjusters having a greater number of claims compared to other adjusters. Such a weighting may provide priority to adjusters having greater experience. As described herein, historic data may be provided in adjuster profiles which may be stored on and accessed from a remote server 220, or the like. In non-limiting examples, the claims analysis module 212 may additionally or alternative apply a weight based on a threshold experience level, such as based on a global average number of claims adjusted by adjusters. For instance, adjusters having adjusted a number of claims over a threshold percentage number of claims above a global average number of claims (e.g., over about 10%, about 20%, etc.) may be given priority.

As described above, the claims analysis module 212 may apply a weight based on customer or user ratings for each of the plurality of adjusters such that weight is applied to give priority each adjuster of the plurality of adjusters having the user rating that is above a threshold user rating (e.g., in range from about between above 70% to 100%, above 80%, above 90%, etc.). User ratings may be received by the crowdsourcing platform 312, stored in and accessed from a remote server 220, or combinations thereof. The user rating may indicate users' or customers' affinity or satisfaction with a particular adjuster. For example, a user may provide feedback about an adjuster after the adjuster handles the user's claim via an interface, such as via a user device, smart phone, a blender, or the like. The rating may include, for example, an overall rating, a fairness rating, a responsiveness rating, and the like. In an aspect, the rating may include a number of tokens out of a number of possible tokens (e.g., 3 out of 5 stars, etc.), a binary rating (e.g., thumbs up or thumbs down), a numerical score, or the like. It is noted that various other rating or ranking systems may be utilized. Such systems may include different nomenclatures, subcategories, or the like. For instance, a fairness rating may comprise an overall fairness rating and a user's subjective opinion, such as “too little,” “did not consider all evidence,” “just right,” etc. Moreover, ratings may be weighted to account for possible bias from users. In examples, ratings from users issuing several negative ratings for different adjusters may be given less weight. In another example, ratings from users who have appealed a claim or claim amount and lost may be given less weight.

It is noted that weights applied to the one or more weighted parameters may be scaled, tiered or the like. Moreover, while example embodiments may refer to percentages, averages, or the like, other values may be utilized, such as means, medians, point systems, or the like. Moreover, claims analysis module 212 may calculate an overall real-time adjuster priority score based on the one or more weighted parameters via an averaging, summation, or other calculation.

As described herein, the artificial intelligence assignment algorithm 106 (FIG. 1) may be implement via a neural network trained to adjust weights of one or more weighted parameters, adjust scales, add or remove weighted parameters to or from the one or more weighted parameters, or the like. By way of example, and not as a limitation, the neural network may utilize one or more artificial neural networks (ANNs). In ANNs, connections between nodes may form a directed acyclic graph (DAG). ANNs may include node inputs, one or more hidden activation layers, and node outputs, and may be utilized with activation functions in the one or more hiddenactivation layers such as a linear function, a step function, logistic (sigmoid) function, a tanh function, a rectified linear unit (ReLu) function, or combinations thereof. ANNs are trained by applying such activation functions to training data sets to determine an optimized solution from adjustable weights and biases applied to nodes within the hidden activation layers to generate one or more outputs as the optimized solution with a minimized error.

In machine learning applications, new inputs may be provided (such as the generated one or more outputs) to the ANN model as training data to continue to improve accuracy and minimize error of the ANN model. The one or more ANN models may utilize one to one, one to many, many to one, and/or many to many (e.g., sequence to sequence) sequence modeling. The intelligent adjuster assignment system 200 may utilize one or more ANN models as understood to those skilled in the art or as yet-to-be-developed to adjust weights, determine adjuster priority scores, and/or assign adjusters to insurance claims as described in embodiments herein. Such ANN models may include artificial intelligence components selected from the group that may include, but not be limited to, an artificial intelligence engine, Bayesian inference engine, and a decision-making engine, and may have an adaptive learning engine further comprising a deep neural network learning engine. The one or more ANN models may employ a combination of artificial intelligence techniques, such as, but not limited to, Deep Learning, Random Forest Classifiers, Feature extraction from insurance claims, insurance claim evidence, audio, images, clustering algorithms, or combinations thereof.

In embodiments, a convolutional neural network (CNN) may be utilized. For example, a convolutional neural network (CNN) may be used as an ANN that, in a field of machine learning, for example, is a class of deep, feed-forward ANNs applied for adjuster assignment weights. CNNs may be shift or space invariant and utilize shared-weight architecture and translation invariance characteristics. Additionally or alternatively, a recurrent neural network (RNN) may be used as an ANN that is a feedback neural network. RNNs may use an internal memory state to process variable length sequences of inputs to generate one or more outputs. In RNNs, connections between nodes may form a DAG along a temporal sequence. One or more different types of RNNs may be used such as a standard RNN, a Long Short Term Memory (LSTM) RNN architecture, and/or a Gated Recurrent Unit RNN architecture.

In embodiments, a GRU may allow for claim parameters and adjuster parameters to be analyzed against memory data associated with a plurality adjusters parameters and past claim assignments prior to comparing competing adjusters to real-time adjuster priority scores. The GRU may provide memory of previously analyzed adjuster assignments to inform the impact of the current adjuster assignments to generate the real-time adjuster priority scores for the current adjuster assignments.

The claims analysis module 212 may include a training module 212A which may process training data sets of pre-stored claim assignments and results to train one or more models (such as the machine learning adjuster assignment model 108 of FIG. 1) within which a current claim, claim assignment, or other data may be fed for prediction of claim assignment probability. Training data sets stored and manipulated in the intelligent adjuster assignment system 200 as described herein may be utilized by the machine-learning module 216, which is able to leverage, for example, a cloud computing-based network configuration to apply Machine Learning and Artificial Intelligence. This machine learning application may create models that can be applied by the intelligent adjuster assignment system 200, to make it more efficient and intelligent in execution. As an example and not a limitation, the machine-learning module 216 may include artificial intelligence components selected from the group consisting of an artificial intelligence engine, Bayesian inference engine, and a decision-making engine, and may have an adaptive learning engine further comprising a deep neural network-learning engine. It is contemplated and within the scope of this disclosure that the term “deep” with respect to the deep neural network-learning engine is a term of art readily understood by one of ordinary skill in the art.

As described above, claims analysis module 212 may determine a top-ranked adjuster from the plurality of adjusters based on the plurality of real-time adjuster priority scores and may assign the insurance claim to the top-ranked adjuster. In some embodiments, the claims analysis module 212 may identify one or more top-ranked adjusters that may have a highest real-time adjuster priority score, real-time adjuster priority scores over a threshold value (e.g., top 10% of real-time adjuster priority scores), or the like. In instances where a plurality of adjusters are determined to be top-ranked adjusters, the claims analysis module 212 may generate notifications to the plurality of top-ranked adjusters, such as via the adjuster portal 314 and/or network 222. The claims analysis module 212 may then receive input from one or more of the plurality of top-ranked adjusters and may assign an adjuster accordingly, such as based on the first adjuster to respond or accept an assignment, a number of cases or workload associated with adjusters, or the like. In other embodiments, the claims analysis module 212 may select an adjuster that has the fewest or least recent assignments. This may encourage adjusters to remain active in the crowdsourcing platform 312. It is further noted that the claims analysis module 212 may generate notifications to the input/output device 250 associated with an adjuster, the remote server 220, system administrators, or other suitable devices or persons to receive such notifications.

Referring to FIG. 4, a process 400 is shown for use with the adjuster assignment solution 100 of FIG. 1 and intelligent adjuster assignment system 200 of FIG. 2 to assign an insurance claim to an adjuster from a plurality of adjusters in a crowdsourcing platform. It is noted that a greater or fewer number of steps may be included without departing from the scope of the present disclosure.

For example, in some embodiments, at block 402 of the process, the one or more processors 204 may receiving an insurance claim during a time period. The insurance claim may be received via the network 222 (FIG. 2), via a telephone call, or through other claim receipt means as understood to those of skill in the art. In embodiments, the insurance claim may provide or include one or more parameters, such as a claimant ID, insurance plan or policy data, loss data, location data, time data, or the like. The time period may indicate a time of an incident and/or a time that the insurance claim was made.

In an embodiment, at block 404 of the process 400, the one or more processors 204 (FIG. 2) may determine real-time adjuster priority scores based on one or more weighted parameters for a plurality of adjusters. The real-time priority scores may be determined by a claims analysis module 212 applying the machine learning adjuster assignment model 108 that employs the artificial intelligence assignment algorithm 106 (See FIG. 1). Moreover, real-time priority scores may be calculated based on weighted algorithms, weighted models, or the like.

As described herein, the one or more weighted parameters may be based on historic data associated with the plurality of adjusters, received data from adjusters, received data from claimants, received data from third parties, or other forms of received data. In another aspect, the process 400 may receive input from adjusters, such as bids, availability (e.g., whether or not the adjuster is accepting assignments), location data, or the like. Received information may be utilized as one or more weighted parameters and/or indicate whether to include an adjuster in a pool of adjusters.

At block 406 of the process 400, the one or more processors 204 (FIG. 2) may determine a top-ranked adjuster from the plurality of adjusters based on the real-time adjuster priority scores. The top-ranked adjuster may be determined based on an absolute score, a score over a threshold score value, or the like, that ranks the top-ranked adjuster above other ranked adjusters. It is further noted that the process 400 may including identifying a plurality of adjusters as top-ranked adjusters, such as a plurality of top-ranked adjusters having same scores, scores within a determined amount of each other, scores over a threshold value (e.g., top 10% of real-time adjuster priority scores), or the like. In some embodiments, process 400 may including generating notifications over a network 222 (FIG. 2) such as via an adjuster portal 314 (FIG. 3). The notifications may be transmitted to the user devices 330 associated with adjusters and adjusters may provide input to accept an assignment. In some embodiments, adjusters may be automatically assigned. Moreover, the process 400 may include receiving input (e.g., acceptance of an assignment) from adjusters to select a top-ranked adjuster from a plurality of top-ranked adjusters.

At block 406 of the process 400, the one or more processors 204 (FIG. 2) may assign the insurance claim to the top-ranked adjuster. Assignment of the insurance claim may comprise associating the adjuster with the particular claim, transmit insurance claim information to a user device 330 (FIG. 3) associated with the adjuster, allowing access to insurance claim information, or the like. In other examples, an administrator may be notified of an assignment and may contact an adjuster. Moreover, tasks may be assigned to an adjuster to complete processing of the insurance claim.

For the purposes of describing and defining the present disclosure, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is noted that recitations herein of “at least one” component, element, etc., should not be used to create an inference that the alternative use of the articles “a” or “an” should be limited to a single component, element, etc. It is also noted that recitations herein of a component of the present disclosure being “configured” or “programmed” in a particular way, to embody a particular property, or to function in a particular manner, are structural recitations, as opposed to recitations of intended use.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

It is noted that one or more of the following claims utilize the term “wherein” as a transitional phrase. For the purposes of defining the present disclosure, it is noted that this term is an open-ended transitional term that is used to introduce a recitation of a series of characteristics of the structure and should be interpreted in like manner as the more commonly used open-ended preamble term “comprising.”

### Aspects Listing

Aspect 1. An intelligent adjuster assignment system includes a crowdsourcing platform, one or more processors, one or more memory components communicatively coupled to the one or more processors and the crowdsourcing platform, and machine readable instructions stored in the one or more memory components. The machine readable instructions cause the intelligent adjuster assignment system to perform at least the following when executed by the one or more processors: receive an insurance claim during a period of time, determine a plurality of real-time adjuster priority scores based on one or more weighted parameters for a plurality of adjusters of an adjuster pool on the crowdsourcing platform during the period of time, determine a top-ranked adjuster from the plurality of adjusters based on the plurality of real-time adjuster priority scores, and assign the insurance claim to the top-ranked adjuster.

Aspect 2. The intelligent adjuster assignment system of Aspect 1, wherein the crowdsourcing platform is configured to provide an adjuster portal configured to allow the plurality of adjusters to login to the crowdsourcing platform, and identify via the adjuster portal each of the plurality of adjusters as actively accepting claims or not actively accepting claims.

Aspect 3. The intelligent adjuster assignment system of Aspect 2, further comprising machine readable instructions stored in the one or more memory components that cause the intelligent adjuster assignment system to perform at least the following when executed by the one or more processor: select adjusters that are identified as actively accepting claims for the plurality of adjusters from the adjuster pool.

Aspect 4. The intelligent adjuster assignment system of any preceding Aspect, wherein the one or more weighted parameters comprises at least one of: an adjuster rating based on whether the adjuster is a customer of an insurance platform provider; an adjuster location rating based on a distance each of the plurality of adjusters is to a location defined by the insurance claim; an average insurance claims settlement cycle time value for each of the plurality of adjusters; a platform average winning bid value; a history of success settlement parameter; a number of claims adjusted parameter; an adjuster history parameter including legal history; a user rating for each of the plurality of adjusters; a reverse bidding algorithm to indicate adjuster preference; or a combination thereof.

Aspect 5. The intelligent adjuster assignment system of Aspect 4, wherein the adjuster location rating is weighted to prioritize shorter distances such that each of the plurality of adjusters that is a shorter distance to the location defined by the insurance claim receive priority over farther distances.

Aspect 6. The intelligent adjuster assignment system of Aspect 4 or Aspect 5, wherein the average insurance claims settlement cycle time value for each of the plurality of adjusters is weighted such that priority is given to each adjuster of the plurality of adjusters that has the average insurance claims settlement cycle time value under a threshold percentage of a global average insurance claims settlement cycle time.

Aspect 7. The intelligent adjuster assignment system of any of Aspect 4 to Aspect 6, wherein the platform average winning bid value is weighted such that priority is given to each adjuster of the plurality of adjusters having a bid that is lower than the platform average winning bid value.

Aspect 8. The intelligent adjuster assignment system of any of Aspect 4 to Aspect 7, wherein the history of success settlement parameter comprises a percentage score indicative of an amount of times a quote is unchallenged, and wherein the history of success settlement parameter is weighted such that priority is given to each adjuster of the plurality of adjusters having the percentage score indicative of the amount of times the quote is unchallenged that is greater than an unchallenged threshold value.

Aspect 9. The intelligent adjuster assignment system of any of Aspect 4 to Aspect 8, wherein the number of claims adjusted parameter is weighted such that priority is given to each adjuster of the plurality of adjusters having a greater number of claims compared to other adjusters.

Aspect 10. The intelligent adjuster assignment system of any of Aspect 4 to Aspect 9, wherein the user rating for each of the plurality of adjusters is weighted such that priority is given to each adjuster of the plurality of adjusters having the user rating that is above a threshold user rating.

Aspect 11. The intelligent adjuster assignment system of any of Aspect 4 to Aspect 10, wherein the machine readable instructions stored in the one or more memory components includes the reverse bidding algorithm that further cause the intelligent adjuster assignment system to perform at least the following when executed by the one or more processors: receive a bid from at least one adjuster of the plurality of adjusters; and assign a bid score to the at least one adjuster based on a comparison of the bid to at least one of a platform bid average or one or more competitive bids from other adjusters of the plurality of adjusters.

Aspect 12. The intelligent adjuster assignment system of Aspect 11, wherein the reverse bidding algorithm further cause the intelligent adjuster assignment system to perform at least the following when executed by the one or more processors: assign priority to the at least one adjuster having the bid score that is within a predetermined percentage of a highest bid score.

Aspect 13. The intelligent adjuster assignment system of any preceding Aspect, further comprising machine readable instructions that cause the intelligent adjuster assignment system to perform at least the following when executed by the one or more processors: train the intelligent adjuster assignment system to adjust the one or more weighted parameters based on a history of claim assignments for each adjuster.

Aspect 14. An intelligent adjuster assignment system a crowdsourcing platform, one or more processors, one or more memory components communicatively coupled to the one or more processors and the crowdsourcing platform, and machine readable instructions stored in the one or more memory components. The machine readable instructions cause the intelligent adjuster assignment system to perform at least the following when executed by the one or more processors: receive an insurance claim during a period of time, determine a plurality of real-time adjuster priority scores based on one or more weighted parameters for a plurality of adjusters of an adjuster pool on the crowdsourcing platform during the period of time, select adjusters that are identified as actively accepting claims for the plurality of adjusters from the adjuster pool, determine a top-ranked adjuster from the plurality of adjusters that are actively accepting claims based on the plurality of real-time adjuster priority scores, assign the insurance claim to the top-ranked adjuster, and train the intelligent adjuster assignment system to adjust the one or more weighted parameters based on a history of claim assignments for each adjuster.

Aspect 15. The intelligent adjuster assignment system of Aspect 14, wherein the one or more weighted parameters comprises at least one of: an adjuster rating based on whether the adjuster is a customer of an insurance platform provider; an adjuster location rating based on a distance each of the plurality of adjusters is to a location defined by the insurance claim; an average insurance claims settlement cycle time value for each of the plurality of adjusters; a platform average winning bid value; a history of success settlement parameter; a number of claims adjusted parameter; an adjuster history parameter including legal history; a user rating for each of the plurality of adjusters; a reverse bidding algorithm to indicate adjuster preference; or a combination thereof.

Aspect 16. The intelligent adjuster assignment system of Aspect 14 or Aspect 15, wherein the crowdsourcing platform is configured to: provide an adjuster portal configured to allow the plurality of adjusters to login to the crowdsourcing platform; and identify via the adjuster portal each of the plurality of adjusters as actively accepting claims or not actively accepting claims.

Aspect 17. A method of implementing an intelligent adjuster assignment system includes receiving an insurance claim during a period of time, determining a plurality of real-time adjuster priority scores based on one or more weighted parameters for a plurality of adjusters of an adjuster pool on a crowdsourcing platform during the period of time, determining a top-ranked adjuster from the plurality of adjusters based on the plurality of real-time adjuster priority scores, and assigning the insurance claim to the top-ranked adjuster.

Aspect 18. The method of Aspect 17, further including selecting adjusters that are identified as actively accepting claims for the plurality of adjusters from the adjuster pool.

Aspect 19. The method of Aspect 17 or Aspect 18, wherein the one or more weighted parameters comprises at least one of: an adjuster rating based on whether the adjuster is a customer of an insurance platform provider; an adjuster location rating based on a distance each of the plurality of adjusters is to a location defined by the insurance claim; an average insurance claims settlement cycle time value for each of the plurality of adjusters; a platform average winning bid value; a history of success settlement parameter; a number of claims adjusted parameter; an adjuster history parameter including legal history; a user rating for each of the plurality of adjusters; a reverse bidding algorithm to indicate adjuster preference; or a combination thereof.

Aspect 20. The method of any of Aspect 17 to Aspect 19, further including training the intelligent adjuster assignment system to adjust the one or more weighted parameters based on a history of claims assignments for each adjuster.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An intelligent adjuster assignment system comprising:
a crowdsourcing platform;
one or more processors;
one or more memory components communicatively coupled to the one or more processors and the crowdsourcing platform; and
machine readable instructions stored in the one or more memory components that cause the intelligent adjuster assignment system to perform at least the following when executed by the one or more processors:
receive an insurance claim during a period of time;
determine a plurality of real-time adjuster priority scores based on one or more weighted parameters for a plurality of adjusters of an adjuster pool on the crowdsourcing platform during the period of time;
determine a top-ranked adjuster from the plurality of adjusters based on the plurality of real-time adjuster priority scores; and
assign the insurance claim to the top-ranked adjuster.

2. The intelligent adjuster assignment system of claim 1, wherein the crowdsourcing platform is configured to:
provide an adjuster portal configured to allow the plurality of adjusters to login to the crowdsourcing platform; and
identify via the adjuster portal each of the plurality of adjusters as actively accepting claims or not actively accepting claims.

3. The intelligent adjuster assignment system of claim 2, further comprising machine readable instructions stored in the one or more memory components that cause the intelligent adjuster assignment system to perform at least the following when executed by the one or more processors:
select adjusters that are identified as actively accepting claims for the plurality of adjusters from the adjuster pool.

4. The intelligent adjuster assignment system of claim 1, wherein the one or more weighted parameters comprises at least one of:
an adjuster rating based on whether the adjuster is a customer of an insurance platform provider;
an adjuster location rating based on a distance each of the plurality of adjusters is to a location defined by the insurance claim;
an average insurance claims settlement cycle time value for each of the plurality of adjusters;
a platform average winning bid value;
a history of success settlement parameter;
a number of claims adjusted parameter;
an adjuster history parameter including legal history;
a user rating for each of the plurality of adjusters;
a reverse bidding algorithm to indicate adjuster preference; or
a combination thereof.

5. The intelligent adjuster assignment system of claim 4, wherein the adjuster location rating is weighted to prioritize shorter distances such that each of the plurality of adjusters that is a shorter distance to the location defined by the insurance claim receive priority over farther distances.

6. The intelligent adjuster assignment system of claim 4, wherein the average insurance claims settlement cycle time value for each of the plurality of adjusters is weighted such that priority is given to each adjuster of the plurality of adjusters that has the average insurance claims settlement cycle time value under a threshold percentage of a global average insurance claims settlement cycle time.

7. The intelligent adjuster assignment system of claim 4, wherein the platform average winning bid value is weighted such that priority is given to each adjuster of the plurality of adjusters having a bid that is lower than the platform average winning bid value.

8. The intelligent adjuster assignment system of claim 4, wherein the history of success settlement parameter comprises a percentage score indicative of an amount of times a quote is unchallenged, and wherein the history of success settlement parameter is weighted such that priority is given to each adjuster of the plurality of adjusters having the percentage score indicative of the amount of times the quote is unchallenged that is greater than an unchallenged threshold value.

9. The intelligent adjuster assignment system of claim 4, wherein the number of claims adjusted parameter is weighted such that priority is given to each adjuster of the plurality of adjusters having a greater number of claims compared to other adjusters.

10. The intelligent adjuster assignment system of claim 4, wherein the user rating for each of the plurality of adjusters is weighted such that priority is given to each adjuster of the plurality of adjusters having the user rating that is above a threshold user rating.

11. The intelligent adjuster assignment system of claim 4, wherein the machine readable instructions stored in the one or more memory components includes the reverse bidding algorithm that further cause the intelligent adjuster assignment system to perform at least the following when executed by the one or more processors:
receive a bid from at least one adjuster of the plurality of adjusters; and
assign a bid score to the at least one adjuster based on a comparison of the bid to at least one of a platform bid average or one or more competitive bids from other adjusters of the plurality of adjusters.

12. The intelligent adjuster assignment system of claim 11, wherein the reverse bidding algorithm further cause the intelligent adjuster assignment system to perform at least the following when executed by the one or more processors:
assign priority to the at least one adjuster having the bid score that is within a predetermined percentage of a highest bid score.

13. The intelligent adjuster assignment system of claim 1, further comprising machine readable instructions that cause the intelligent adjuster assignment system to perform at least the following when executed by the one or more processors:
train the intelligent adjuster assignment system to adjust the one or more weighted parameters based on a history of claim assignments for each adjuster.

14. An intelligent adjuster assignment system comprising:
a crowdsourcing platform;
one or more processors;
one or more memory components communicatively coupled to the one or more processors and the crowdsourcing platform; and
machine readable instructions stored in the one or more memory components that cause the intelligent adjuster assignment system to perform at least the following when executed by the one or more processors:
receive an insurance claim during a period of time;
determine a plurality of real-time adjuster priority scores based on one or more weighted parameters for a plurality of adjusters of an adjuster pool on the crowdsourcing platform during the period of time;
select adjusters that are identified as actively accepting claims for the plurality of adjusters from the adjuster pool;
determine a top-ranked adjuster from the plurality of adjusters that are actively accepting claims based on the plurality of real-time adjuster priority scores;
assign the insurance claim to the top-ranked adjuster; and
train the intelligent adjuster assignment system to adjust the one or more weighted parameters based on a history of claim assignments for each adjuster.

15. The intelligent adjuster assignment system of claim 14, wherein the one or more weighted parameters comprises at least one of:
an adjuster rating based on whether the adjuster is a customer of an insurance platform provider;
an adjuster location rating based on a distance each of the plurality of adjusters is to a location defined by the insurance claim;
an average insurance claims settlement cycle time value for each of the plurality of adjusters;
a platform average winning bid value;
a history of success settlement parameter;
a number of claims adjusted parameter;
an adjuster history parameter including legal history;
a user rating for each of the plurality of adjusters;
a reverse bidding algorithm to indicate adjuster preference; or
a combination thereof.

16. The intelligent adjuster assignment system of claim 14, wherein the crowdsourcing platform is configured to:
provide an adjuster portal configured to allow the plurality of adjusters to login to the crowdsourcing platform; and
identify via the adjuster portal each of the plurality of adjusters as actively accepting claims or not actively accepting claims.

17. A method of implementing an intelligent adjuster assignment system, the method comprising:
receiving an insurance claim during a period of time;
determining a plurality of real-time adjuster priority scores based on one or more weighted parameters for a plurality of adjusters of an adjuster pool on a crowdsourcing platform during the period of time;
determining a top-ranked adjuster from the plurality of adjusters based on the plurality of real-time adjuster priority scores; and
assigning the insurance claim to the top-ranked adjuster.

18. The method of claim 17, further comprising selecting adjusters that are identified as actively accepting claims for the plurality of adjusters from the adjuster pool.

19. The method of claim 17, wherein the one or more weighted parameters comprises at least one of:
an adjuster rating based on whether the adjuster is a customer of an insurance platform provider;
an adjuster location rating based on a distance each of the plurality of adjusters is to a location defined by the insurance claim;
an average insurance claims settlement cycle time value for each of the plurality of adjusters;
a platform average winning bid value;
a history of success settlement parameter;
a number of claims adjusted parameter;
an adjuster history parameter including legal history;
a user rating for each of the plurality of adjusters;
a reverse bidding algorithm to indicate adjuster preference; or
a combination thereof.

20. The method of claim 17, further comprising training the intelligent adjuster assignment system to adjust the one or more weighted parameters based on a history of claims assignments for each adjuster.
